(19) United States
(12) Patent Application Publication
(10) Pub. No.: US 2025/0320337 A1
(43) Pub. Date: Oct. 16, 2025

(54) SHEET MOLDING COMPOSITION AND ARTICLES FORMED THEREFROM WITH HIGH CHAR STRENGTH

(71) Applicant: Teijin Automotive Technologies, Inc., Auburn Hills, MI (US)

(72) Inventors: Hugh MacDowell, Auburn Hills, MI (US); Steven Prascius, Auburn Hills, MI (US); Michael Hiltunen, Auburn Hills, MI (US); Austin Pakkala, Auburn Hills, MI (US)

(73) Assignee: Teijin Automotive Technologies, Inc., Auburn Hills, MI (US)

(21) Appl. No.: 18/869,889

(22) PCT Filed: May 31, 2023
(86) PCT No.: PCT/US2023/023967

§ 371 Date: Nov. 27, 2024

Related U.S. Application Data
(60) Provisional application No. 63/347,591, filed on Jun. 1, 2022.

(51) Int. Cl. C08J 5/18; C08K 5/3492; C08K 5/52; C08K 5/521; C08L 33/14; C08L 51/08; C08L 61/12; C08L 63/00

(52) U.S. Cl. CPC C08J 5/18; C08K 5/34928; C08K 5/5205; C08K 5/521; C08L 33/14; C08L 51/08; C08L 61/12; C08L 63/00; C08J 2333/14; C08J 2351/08; C08J 2361/12; C08J 2363/00; C08J 2479/04; C08L 2201/02

(57) ABSTRACT

A sheet molding compound (SMC) composition formulation including a curable resin, such as unsaturated polyester of vinyl ester, in an ethylenically unsaturated monomer; a low profile additive, in a curable solvent; and an intumescent additive, such as melamine polyphosphate or ethylene diamine phosphate. An article formed of the SMC composition formulation experiences no more than a 100% increase in thickness as compared to an initial thickness of the article after exposure to a flame. The low profile additive is present in the composition and the intumescent additive is present in the composition. The resulting article has a char strength at 3 mm thickness of between 100 and 1,000 Newtons.

### RELATED APPLICATIONS

This application claims priority benefit of U.S. Provisional Application Ser. No. 63/347,591 filed 1 Jun. 2022; the contents of which are hereby incorporated by reference.

### FIELD OF THE INVENTION

The present invention in general relates to Sheet Molding Compound (SMC) and methods of forming the same and in particular, to an SMC includes a low profile additive (LPA) and an intumescent filler that impart flame retardancy and heat absorption while also providing a high char strength.

### BACKGROUND OF THE INVENTION

Thermoset molding compositions known in the art are generally thermosetting resins containing inorganic fillers and/or fibers. Upon heating, thermoset monomers initially exhibit viscosities low enough to allow for melt processing and molding of an article from the filled monomer composition. Upon further heating, the thermosetting monomers react and cure to form hard resins.

A common industrial use of thermoset compositions is the molding of automotive components. These panels exhibit high dimensional stability and a high gloss molded surface finish required for exposed vehicle surfaces. Automotive components must also have a high degree of dimensional uniformity and stability relative to the preparatory molds so as to maintain the high degree of fit and finish required in modern vehicle manufacturing.

There is growing regulatory demand for lightweight vehicle components that also have improved fire retardancy. Exemplary of these standards is the European Union enacted EN 45545-2 safety standard. Key parameters that are measured for compliance with the EN 45545-2 standard include flame spread, ignitability, heat release, smoke opacity and toxicity. Having passed the tests, adhesives, sealants, and products for molding and protecting electronics and other structural components are given approval according to EN 45545-2 for use in trains. Another example of important test standards for burning of plastic materials includes determining the material's tendency to either extinguish or spread the flame once the specimen has been ignited, for example as described in UL 94, the Standard for Tests for Flammability of Plastic Materials for Parts in Devices and Appliances, and in particular UL 94-5VA.

Thermoset compositions based on unsaturated polyester, unsaturated vinylester, or polyurethane resins and styrene are known to exhibit reduced shrinkage and improved surface properties through the inclusion of inclusions of a low-profile additive (LPA). An LPA is a thermoplastic particle included in the uncured resin to improve the surface finish through shrinkage compensation. Dong, J-P, et al. Journal of Applied Polymer Science, 98(1) (2005): 264-275; and Chan-Park M. B. et al. Polymer Composites, 17(4) (1986), 537-547. Conventional LPAs include saturated polyesters, polyvinylacetates, polystryenes, polyethylenes, polypropylenes, polymethacrylates, and copolymers in which any of the aforementioned represent at least 40 percent of the monomeric subunits of the copolymer. Although known low-profile additives improve the performance of the polyester and polyurethane thermosets, there is a need for compositions exhibiting further improvements, particularly as to surface flame and fire retardancy.

Thus, there exists a need for a molding compound composition suitable for usage in and SMC-based vehicle component production that retains article dimensional uniformity and stability relative to the preparatory molds and that exhibits a high quality blister-free surface appearance. There further exists a need for improved fire resistance and char yield compared to components made from conventional resin based formulations. Furthermore, there exists a need for such improved fire resistant resin based formulations that provide high-strength characteristics even after being subjected to flame and charring.

### BRIEF DESCRIPTION OF THE DRAWINGS

The present invention is further detailed with respect to the following drawings that are intended to show certain aspects of the present invention but should not be construed as a limit on the practice of the present invention.

The FIGURE is a graph showing normalized heat flow of a component formed of an inventive SMC composition according to embodiments of the present disclosure; and

### SUMMARY OF THE INVENTION

The present invention provides a sheet molding compound (SMC) composition formulation that includes a curable resin, such as unsaturated polyester of vinyl ester, in an ethylenically unsaturated monomer; a low profile additive, and an intumescent additive, such as melamine polyphosphate or ethylene diamine phosphate. A residual charred piece formed of the SMC composition formulation experiences no more than a 200% increase in thickness as compared to an initial thickness of the article prior to flame burn through and a strength of from 100 to 1000 Newtons. In some inventive embodiments, the backside temperature when exposed to a 900 degree Celsius flame is less than 400 degrees Celsius. The low profile additive is present in an amount of 5 to 10 weight percent or more of the composition and the intumescent additive is present in an amount of 10 to 50 weight percent of the composition without regard to any fiber fillers.

### DESCRIPTION OF THE INVENTION

The present invention has utility as an SMC composition that provides improved fire and flame retardance to cured components formed of the inventive SMC composition compared to conventional SMC components and that provides high-strength characteristics even after being subjected to flame and charring. According to some inventive embodiments, the inventive SMC composition includes a synergistic combination of a resin, an intumescent filler, and a low-profile additive (LPA) that give the resulting SMC composition and articles formed therefrom the unique combination of characteristics including flame resistance, char strength, and thermal insulation. According to some inventive embodiments, the SMC composition includes benzoxazine as a low-profile additive (LPA) and an intumescent filler. The inclusion of benzoxazine as a low-profile additive in some polymer-based sheet molding composition (SMC) results in a surprising increase in flame and fire retardancy and heat absorption in cured articles made therefrom while maintaining dimensional control requirements and surface finish requirements. The present invention is in contrast to SMC in which the cured matrix is formed of benzoxazine, as detailed in US20210245405.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

According to some inventive embodiments, the inventive SMC composition additionally includes chopped fibers. The typical length of the chopped fibers according to the present invention is between 10 and 50 mm. A typical thickness of a molded article formed of an SMC composition according to the present invention is between 0.7 and 10 mm. In some inventive embodiments, the inventive fiber reinforced thermoset SMC formulations are compression moldable with short cycle times with SMC resins that cure at temperatures of between 140-160° C. and have the ability to flow and mold complex shapes. To the extent that formulations are detailed hereafter as to parts per hundred by weight, these are exclusive of such chopped fibers unless noted to the contrary.

According to inventive embodiments, the present disclosure provides an SMC composition that includes a resin matrix, an intumescent filler, and a low-profile additive (LPA). The synergistic combination of the components that make up the SMC composition provides improved fire and flame retardance, improved char strength, and improved thermal insulation to cured components formed of the inventive SMC composition compared to conventional SMC components. The present invention additionally modifies the coefficient of linear thermal expansion compared to a like SMC lacking an LPA to mitigate shrinkage upon curing of the compositions. Additionally, components formed of the inventive composition in some embodiments feature an improved surface finish that is amenable to receiving a highly uniform paint or coating meeting the exacting finished surface requirements of the automotive industry. This surface upon preparation and final sealing and/or painting is commonly referred to in the industry as a class “A”. Reinforcing fibers are also commonly present in an inventive SMC and if present, in an amount of between 0.1 and 65 weight percent. Reinforcing fibers operative herein include, glass, basalt, carbon, polyaramid, natural fibers, and combinations thereof.

According to some inventive embodiments, the resin matrix is a low density molding compound formulation having a specific gravity of less than 1.65 and in some inventive embodiments, as low as 0.89 is provided that includes a thermoset cross-linkable unsaturated polyester or vinyl ester.

A process for producing such a molding compound panel includes dispersing benzoxazine or polycarbonate as a low profile additive (LPA) package in a solvent. Solvents operative herein illustratively include styrene, alpha-methylstyrene, vinyl toluene, di-functional styrene, chlorostyrene, allyl substituted benzene, di-vinyl benzene, cardanol, triethyl phosphate, acrylates, methacrylates, or other phenol containing solvents, and combinations of any of the aforementioned. It is appreciated that the LPA solvent should be miscible with the ethylenically unsaturated monomer for the curable resin component of the SMC and as a result, there can be overlap between these solvents and the monomer. The LPA is then dispersed with other components in the molding formulation and curing the thermoset components in the shape of a desired article is achieved through contact with a mold platen. In some inventive embodiments, the complete, uncured formulation flows having a molding viscosity. Viscosities of between 10 and 50 million Centipoise are especially desirous to promote handling in a production setting. At least one of the surface appearance, the dimensional stability, the flame retardance, char strength, and thermal insulation of the cured article are observed to be improved by at least an order of magnitude compared to a like article formed from with conventional SMC.

The low profile additive is provided to improve at least one of surface properties, dimensional stability, and flame and fire retardancy of a resulting molded product. While it is appreciated that most conventional low profile additives are blends or mixtures of several thermoplastic polymers that are dissolved or dispersed in a solvent such as styrene, a low profile additive operative in the present invention includes domains of benzoxazine polymer or polycarbonate. Notably, the domains of benzoxazine polymer do not cross link with the resin. Instead, these domains of benzoxazine polymer tend to position near the surface of a component formed of the inventive SMC composition, thereby improving the surface appearance and dimensional stability thereof upon cure and forming a char layer upon exposure to fire. This char layer acting to retard further burning of the component formed of the inventive composition or nearby materials. According to some inventive embodiments, the SMC composition includes up to 50 weight percent benzoxazine resin in the solvent. According to embodiments, the domains of benzoxazine polymer are at least partially dissolved in styrene or other matrix curable aromatic solvent (50 weight percent or more of LPA). Benzoxazine polymer operative herein typically has a weighted average molecular weight, Mw of between 200 and 50,000. Weighted average molecular weight, Mw as determined by gel permeation chromatography.

According to some inventive embodiments, formulations of the inventive SMC composition are provided in Table 1.

TABLE 1
Typical and preferred ranges of components in an
inventive composition, in which values are provided in total
weight percentages of the composition.

| | Typical | Preferred |
|---|---|---|
| | Total | Total |
| | Weight | Weight |
| | Percent | Percent |
| Reactants | | |
| Cross-linkable unsaturated polyester, | 5-remainder | 6-remainder |
| vinylester resin, or phenolic resin | | |
| Ethylenically unsaturated monomer | 4-50 | 6-30 |
| (e.g. styrene) | | |
| Reaction Kinetic Modifiers | | |
| Free radical initiation (e.g. peroxide/ | 0-3 | 0.1-1 |
| peroxy ketals, or azo compounds) | | |
| Polymerization inhibitor (e.g., | 0-2 | 0.1-1 |
| hydroquinone) | | |
| Additives | | |
| LPA-Domains of benzoxazine polymer or | 5-60 | 5-15 |
| polycarbonate in aromatic solvent (50% or | | |
| more solvent by weight) | | |
| or other thermoplastic | | |
| Mold release (e.g., stearate additive) | 0-5 | 1-3 |
| Thickeners | 0-5 | 0.5-3 |
| Colorants | 0-4 | 0.1-1 |
| Intumescent additive (at least present): | | |
| Intumescent char former | 0-40 | 20-35 |
| Char promoter (e.g. polyol) | 0-20 | 3-15 |
| Smolder suppressant agent | 0-10 | 1-5 |
| Ceramic former | 0-20 | 5-10 |
| Colorants | 0-3 | 0-1 |
| Fillers | | |
| Particulate filler (e.g., calcium carbonate, | 0-25 | 1-15 |
| alumina trihydrate, basalt, or silica) | | |
| Glass microspheroids | 0-15 | 0-10 |
| Chopped Glass fibers | 0-65 | 35-55 |
| Chopped carbon fiber bundles | 0-10 | 1-5 |
| Additional Intumescent additive | 0-50 | 2-12 |

That is, domains of benzoxazine polymer, polycarbonate, other LPA, or a combination thereof; and the intumescent additive may be added to these base formulations to achieve the above-noted advantages of improved flame and fire retardancy, improved dimensional stability, improved char strength, improved thermal insulation, and improved surface appearance. The improved properties being achieved through limited thickness expansion upon char formation of less than 200% relative to the original SMC article thickness.

To the extent that a substance is explicitly noted herein as multiple functionalities in an inventive formulation, for example as both a intumescent char former and a particle filler, the material loading is equally apportioned therebetween.

A principal component of an inventive SMC composition includes an unsaturated polyester or vinyl ester resin cross-linkable polymer resin. A variety of base SMC formulations are known such as those described in U.S. Pat. Nos. 4,260,538; 4,643,126; 5,100,935; 5,268,400; 5,854,317; 6,001,919; and 6,780,923; and all of these formulations may be used as the base matrix composition of the SMC composition according to embodiments of the present invention. The prepolymer polymeric resin has a molecular weight on average of typically between 400 and 100,000 Daltons. The polyester prepolymer resins typically represent condensation products derived from the condensation of unsaturated dibasic acids and/or anhydrides with polyols. It is appreciated that the saturated di-or poly-acids are also part of the condensation process to form polyester prepolymers with a lesser equivalency of reactive ethylenic unsaturation sites. Unsaturated polyester resins disclosed in U.S. Pat. No. 6,780,923 are preferred for use with the present invention. Still other curable resins operative herein include resole and novolac resins derived from formaldehyde (including other aldehydes) and phenol (including other phenols such as resorcinol and cardanol) with the proviso that the curable aromatic solvent for the LPA is miscible therewith in an uncured state. According to embodiments the resin is an bis-phenol A epoxy vinyl ester, for example DERAKANE® 8084 by Dow or phenolic resins.

As used herein, “unsaturated” refers to covalent bond attachment to the carbon atoms of a carbon-carbon bond being less than a maximal complement of bonding carbon or hydrogen atoms, namely the carbon-carbon bond is a double or triple bond.

The polymeric resin prepolymer is suspended, and preferably dissolved, in an ethylenically unsaturated monomer that copolymerizes with the resin during the thermoset process. It is appreciated that more than one type of monomer can be used in a molding compound. The monomer provides benefits including lower prepolymer viscosity and thermosetting without formation of a volatile byproduct. Ethylenically unsaturated monomer operative herein illustratively includes styrene, alpha-methylstyrene, beta-pinene, camphene, vinyl toluene, cardanol, acrylates, methylacrylates, and chlorostyrene. Styrene is the most commonly used monomer in the formation of SMCs. Other specific monomers operative herein illustratively include trimethylolpropane triacrylate, isobornyl acrylate, isobornyl methacrylate, glycidyl methacrylate. In still other inventive embodiments, monomers are selected that each alone, or as azeotropes have a boiling point at standard temperature and pressure (STP) of greater than 120° C.

A typical molding compound includes a free radical initiator to initiate cross-linking between the polymeric prepolymer resin with itself or with ethylenically unsaturated monomer, if present. A free radical initiator is typically chosen to preclude significant cross-linking at lower temperature so as to control the thermoset conditions. Conventional free radical polymerization initiators contain either a peroxide or azo group. Peroxides operative herein illustratively include benzoyl peroxide, cyclohexanone peroxide, ditertiary butyl peroxide, dicumyl peroxide, tertiary butyl perbenzoate and 1,1-bis(t-butyl peroxy) 3,3,5-trimethylcyclohexane. Azo species operative herein illustratively include azobisisobutyronitrile and t-butylazoisobutyronitrile. While the quantity of free radical polymerization initiator present varies with factors such as desired thermoset temperature and decomposition thermodynamics, an initiator is typically present from 0.1 to 3 total weight percent. In order to lessen cross-linking at temperatures below the desired thermoset temperature, a polymerization inhibitor is often included in base molding formulations. Hydroquinone and t-butyl catechol are conventional inhibitors. An inhibitor is typically present between 0 and 1 total weight percent. Collectively, a polymerization initiator and a polymerization inhibitor, to the extent these are present are selected to contribute less than 100 ppm of decomposition products with a boiling point of between 50-250° C.

Phenolic resins operative herein alone or in combination are based on inclusion of phenols therein. Phenols for use in producing the phenolic resin operative in an inventive SMC composition include phenol, cresol, xylenol, ethylphenol, propylphenol, catechol, resorcin, furfuryl alcohol, hydroquinone, bisphenol-A, bisphenol-F, and combinations thereof. While phenol is prototypical, it is appreciated the other phenols modify functionality, steric effects, and hydrophobicity relative to phenol.

Aldehydes for use in producing the phenolic resin operative in an inventive SMC composition include formaldehyde, paraformaldehyde, benzaldehyde, and combinations thereof. While formaldehyde is prototypical, it is appreciated the other aldehydes modify functionality, steric effects, and hydrophobicity relative to formaldehyde.

Resol phenolic resins, as the term is used herein, are defined to be formed with a pH basic catalyst and, usually but not necessarily, a molar excess of formaldehyde relative to phenol; while in other embodiments, the phenol is in excess relative to formaldehyde. Resol phenolic resins are also conventionally formed at neutral pH and later catalyzed with acid catalysts to a crosslinked solid. The typical number average molecular weight (Mn) of a resol phenolic resin is between 200 and 750. Resol phenolic resins are supplied as liquids or in aqueous or alcoholic solutions with resulting viscosities from 50 to 50,000 Cps, or as solids in the form of lumps, granules, or fine powders. In particular inventive embodiments, the resol phenolic resin is provided as a solution.

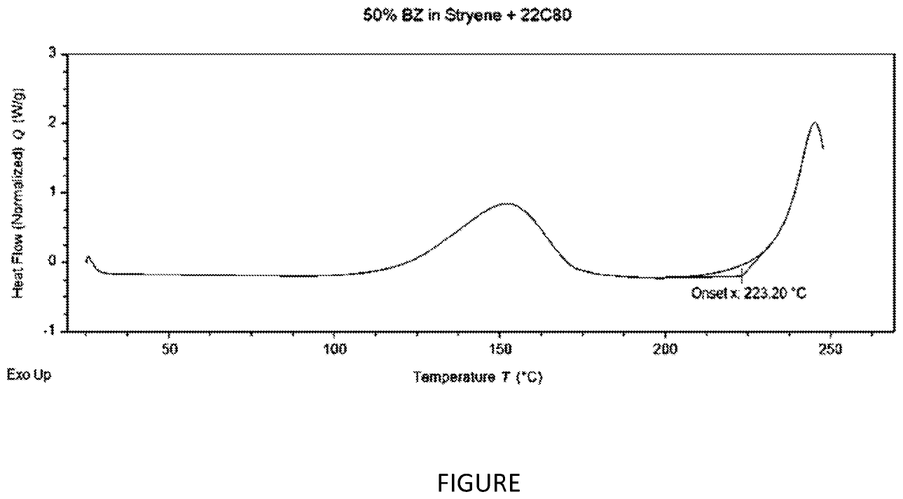

Novolac phenolic resins, as the term is used herein, are defined to be formed with an acidic catalyst and a molar excess of phenol to formaldehyde with water being the condensation by-product with a degree of branching to form a mixture of polymers of different sizes and structures. While not intending to be bound to a particular theory, novolac phenolic resin appears to improve the moldability of an SMC based on limiting resin separation from reinforcing fibers dispersed therein. Additionally, novolac phenolic resin is operative in the present invention adjust the melt viscosity, the cure rate, or a combination thereof of the resulting SMC. Without intending to be bound by a particular theory as the resol and novolac phenolic resins have different cure mechanisms, the inclusion of both types allows one to create viscosity builds as detailed with respect to FIG. 2. Factors relevant in controlling melt viscosity include minimal viscosity reached during curing, cure rate as it pertains to gel time, the amount of Novolac curing agent present, water content, the monomers forming each resins, and others. As a result, a mixture of resol and novolac phenolic resins is particularly useful in formulating an SMC, subject to the proviso that at least one of the phenolic resins is present as a liquid or a solution.

Novolac resins require the presence of a curing agent to complete cure, and as a result the industry commonly refers to novolac resins as two-stage products. The most common phenolic resin curing agent is hexamethylenetetramine (HMTA) that is used as powder dispersed throughout the resin that is activated by heating. A bonding network of aromatic phenolics accounts for the hardness and the heat resistant properties for the resulting articles formed from the SMC. The curing agent is provided premixed with the resin or added as a separate component.

The Mn of novolac phenolic resin operative in the present invention is between 250 and 1200. Novolac phenolic resins are supplied as liquids or in solvents aqueous or alcoholic with resulting viscosities from 50 to 50,000 cps, or as solids in the form of lumps, granules, or fine powders. In some inventive embodiments, the novolac phenolic resin is present as a powder dispersed in a liquid or solution resol phenolic resin.

The inventive SMC composition additionally includes an intumescent additive that functions synergistically with the resin of the SMC resin enhances the char strength and thermal insulation of articles formed of the inventive SMC composition. It has been surprisingly found that limiting the amount char thickness expansion of the SMC article to not exceed 200% of the thickness of the original article when exposed to a flame is a critical factor for balancing the char strength and fire resistance of the cured SMC. According to embodiments, this is accomplished by balancing the combination of the resin used and the intumescent used in forming the inventive SMC composition. According to some inventive embodiments the intumescent char former is melamine polyphosphate, ethylene diamine phosphate, or a combination thereof. Notably, not all combinations of unsaturated polyester (UPE) or vinyl ester (VE) and intumescent additive result in high char yields after burn. However, according to embodiments combinations of a vinyl ester resin, a melamine polyphosphate intumescent filler, and a LPA provide a strong char formation after a 30-minute burn at 900 degrees Celsius. Notably, the char testing is conducted using the Underwriters Lab test UL94-5VA with the flame orthogonal to the article instead of at 45 degree angle. This test measures the propensity of a material to extinguish or spread flames once it becomes ignited. Typical loading of intumescent additive according to the present invention are present in phenolic resins from 15 to 50 parts per hundred by weight (phr) resin and in other resins at 40 to 125 phr resin. It is appreciated that loading in phenolic resins are readily increased beyond 50 phr in some instances. The intumescent additive including at least one of an intumescent char former, a char promoter, or a combination thereof.

In contrast to many SMC compositions that are designed to have heat resistance, those of present invention are readily formulated devoid of metals, while others are formulated devoid of halogens.

The inventive SMC composition in some inventive embodiments includes a particulate filler. Non-conductive particulate fillers operative in such molding compounds illustratively include hollow glass microspheroids, calcium carbonate, calcium silicate, alumina, alumina trihydrate (ATH), silica, talcs, dolomite, basalt, vermiculite, diatomaceous earth, kaolin clay, carbon black, graphene, and combinations thereof. Factors relevant in the choice of a particulate filler illustratively include filler cost, resultant viscosity of flow properties, resultant shrinkage, surface finish weight, flammability, and chemical resistance of the thermoset formulation. Typical filler sizes are from 0.1 to 200 microns. It is appreciated that glass microspheres are preferable surface derivatized in applications where high performance is required. Surface derivatized microspheroids are detailed in U.S. Pat. Nos. 7,700,670; and 9,868,829.

In some inventive embodiments, the surface activating agent molecules covalently bonded to the microspheroid surface have a terminal reactive moiety adapted to bond to a surrounding resin matrix during cure. Without intending to be bound to a particular theory, covalent bonding between a cured resin matrix and the microspheroid increases the delamination strength of the resulting SMC in tests such as ASTM D3359. As used herein, the weight percent of a microspheroid covalently bonded to a surface activating agent is intended to include the weight of the surface activating agent.

A terminal reactive moiety that is reactive with an SMC resin during cure illustratively includes a tertiary amine-; hydroxyl-; imine-; an ethylenic unsaturation, such as an allyl- or acryl-; or cyano-moiety. It is appreciated that matrix cure can occur through mechanisms such as free radical cure, moisture cure, and combinations thereof.

Tertiary amine terminated thermoplastic are readily prepared. D. H. Richards, D. M. Service, and M. J. Stewart, Br. Polym. J. 16, 117 (1984). A representative tertiary amine terminated thermoplastic is commercially available under the trade name ATBN 1300 X 21 from Noveon.

A surface activating agent molecule that bonds to a glass microspheroid is an alkoxysilane where the silane is reactive with the silica surface of the microspheroid. Representative alkoxysilane surface activating agents for the microspheroid illustratively include: 3-aminopropyltrimethoxysilane, 3-aminopropyltriethoxysilane, 3-glycidoxypropyltrimethoxysilane, 3-glycidoxypropyltriethoxysilane, (3-glycidoxypropyl) bis(trimethylsiloxy)methylsilane, (3-glycidoxypropyl)methyldiethoxysilane, (3-glycidoxypropyl) dimethylethoxysilane, (3-glycidoxypropyl)methyldimethoxysilane, methacryloxymethyltriethoxysilane, methacryloxymethyltrimethoxysilane, methacryloxypropyldimethylmethoxysilane, methacryloxypropyldimethylethoxysilane, methacryloxypropyltrimethoxysilane ethacryloxypropylmethyldimethoxysilane, methacryloxypropyltriethoxysilane, methoxymethyltrimethylsilane, 3-methoxypropyltrimethoxysilane, 3-methacryloxypropyldimethylchlorosilane, methacryloxypropylmethyldichlorosilane, methacryloxypropyltrichlorosilane, 3-isocyanatopropyldimethylchlorosilane, 3-isocyanatopropyltriethoxysilane, bis(3-triethoxysilylpropyl)tetrasulfide, and combinations thereof. In certain inventive embodiments, the alkoxysilane surface activating agent includes an ethylenically unsaturated moiety that is reactive under free radical cross-linking conditions so as to covalently bond the microspheroid surface to the surrounding resin matrix.

Alternatively, it is appreciated that microspheroid surface activating agent is readily mixed into the pre-cured SMC formulation and hollow glass microspheres added thereto to induce microsphere activation prior to initiation of matrix cure. Typically, the surface activating agent is present in concentrations of about 0.05 to 0.5 grams of surface activating agent per gram of microspheroids.

A mold release agent is typically provided to promote mold release. Mold releases include polydimethylsiloxane, fatty acid salts illustratively including oleates-, palmitates-, stearates- of metal ions such as sodium, zinc, calcium, magnesium, and lithium. A mold release is typically present from 0 to 5 total weight percent.

It is appreciated that the present invention optionally also incorporates additional additives illustratively including glass microspheres, basalt fillers, plasticizers, colorants, silicas or other char promoters, a smolder suppressant, and other processing additives conventional to the art.

According to some inventive embodiments, a smolder suppressant agent dispersed is also provided from 1 to 10 weight percent without regard to reinforcing fiber filler or particulate filler. A smolder suppressant agent operative herein illustratively includes boric acid, borax, phenylboronic acid, a boroxo siloxane, or a combination thereof. A smolder suppressant agent is dispersed as a powder with particle sizes typically between 0.3 and 500 microns.

An intumescent char former is also provided from 0 to 40 wight percent without regard to reinforcing fiber filler or particulate filler. An intumescent char former operative herein illustratively includes ammonium polyphosphate, melamine polyphosphate, ethanediamine phosphate, phosphoric acids, or a combination thereof.

A char promoter is also provided from 0 to 20 wight percent without regard to reinforcing fiber filler or particulate filler with the proviso that at least one of the intumescent additive or the char promoter is present. A char promoter operative herein includes carbon black, an organophosphate ester, an organobromine, a polyol, or a combination thereof. An organophosphate ester operative herein has the formula (C₁—C₂₀—O)₃P═O. An organobromine operative herein is decabromodiphenyl ether, decabromodiphenyl ethane, or a combination thereof Polyols operative herein illustratively include pentaerythritol; pentaerythritol, glucose, mannose, fructose, galactose, sucrose, lactose, maltose, xylose, arabinose, trehalose and mixtures thereof such as corn syrup; celluloses such as carboxymethylcellulose, ethylcellulose, hydroxyethylcellulose, hydroxy-methylethylcellulose, hydroxyethylpropylcellulose, methylhydroxyethyl-cellulose, methylcellulose; starches such as amylose, seagel, starch acetates, starch hydroxyethyl ethers, ionic starches, long-chain alkyl starches, dextrins, amine starches, phosphate starches, and dialdehyde starches; plant starches such as corn starch and potato starch; other carbohydrates such as pectin, amylopectin, xylan, glycogen, agar, alginic acid, phycocolloids, chitin, gum arabic, guar gum, gum karaya, gum tragacanth and locust bean gum; complex organic substances such as lignin and nitrolignin; derivatives of lignin such as lignosulfonate salts illustratively including calcium lignosulfonate and sodium lignosulfonate and complex carbohydrate-based compositions containing organic and inorganic ingredients such as molasses or honey. In some inventive embodiments, the polyol has a degradation temperature of greater than 120° C. In particular inventive embodiments, the polyol is present from 8 to 15 weight percent absent fiber filler loaded formulation. Inclusion of the polyol results in substantial increases in char strength and backside temperature limitation. Confectioner's sugar is noted to be an inexpensive and highly effective char promoter as noted in the Examples.

As used herein, char yield is determined using thermogravimetric analysis heating at 10° C. per minute under nitrogen to a terminal temperature of 900° C. then switching to air. A ratio of char to ash thereby results.

A ceramic former is also provided from 0 to 10 wight percent without regard to reinforcing fiber filler or particulate filler. A ceramic former operative herein illustratively includes a siloxanes, polysilazanes, carbosilane dendrimers, or a combination thereof. A ceramic former forms a silica under char formation conditions. Siloxanes operative herein include polydimethylsiloxane; amine terminated siloxanes such as aminopropylmethylsiloxane-dimethylsiloxane, aminoethylaminopropylmethylsiloxane-dimethylsiloxane, aminopropyltrimethylsiloxane; and combinations thereof. Polysilazanes operative herein include perhydro-polysilazanes and organopolysilazanes, in which the pendant organic groups are each independently C₁-C₈ alkyl, C₂-C₈ alkenyl, and C₆-C₁₂ aryl groups.

An inventive SMC composition is formulated in certain inventive embodiments to include between 2 volume percent and 33 volume percent of hollow glass microspheres. A glass microsphere has a mean diameter of between 10 and 55 microns. In certain embodiments, the glass microspheres are monodisperse, while in other embodiments; the microsphere sizes extend between 5 and 200 microns. It is appreciated that glass microspheres with higher crush strength are less likely to be damaged by sheer mixing associated with SMC formulation and flow pressures. A 16-micron glass microsphere is exemplary of those used in the following examples. It is appreciated that glass microspheres can be surface modified to enhance strength as detailed in U.S. Pat. No. 7,700,670 B2 or U.S. Pat. Pub. 2015/0376398 A1. The aforementioned volume loading of glass microspheres corresponds to 0.8 to 18 weight percent glass microspheres for conventional 16-micron diameter glass microspheres. It is appreciated that the inclusion of glass microspheres can reduce the density of a resulting article to below 1.6 grams/cubic centimeter (g/cc), below 1.4 g/cc, and even as low as 0.9 g/cc. In some inventive embodiments, the glass microspheres are surface treated with coupling agents to create covalent bonds between the microspheres and a surrounding phenolic resin matrix. Coupling agents operative herein illustratively include γ-aminopropyltriethoxysilane (APTES), di(dioctylpyrophosphato)ethylene titanate, glutaraldehyde, and combinations thereof.

The SMC formulation in some inventive embodiments includes a particulate filler, distinct from the density reducing glass microspheres. Particulate fillers operative in such molding compositions illustratively include calcium carbonate, calcium silicate, alumina, alumina trihydrate (ATH), silica, talcs, dolomite, clays, vermiculite, diatomaceous earth, graphite, metal, phenolic resin particulate, and combinations thereof. To the extent that the particulate filler is phenolic resin particulate, the phenolic resin particulate is counted toward the total amount of phenolic resin. Factors relevant in the choice of a particulate filler illustratively include pH, filler cost, resultant viscosity of flow properties, resultant shrinkage, surface finish weight, flammability, electrical conductivity, and chemical resistance of the thermoset formulation. Particulate filler typically accounts from 0 to 40 weight percent. Typical filler sizes are from 0.1 to 50 microns.

The viscosity builds from the initial viscosity to 36 hours, from 36 to 142 hours, and then from 142 hours to 176 hours to define a slope ratio of viscosities in these time ranges of 1.5-8:1:-0.4-2 and a having terminal viscosity as measured at 176 hours. Alternatively, the initial viscosity is between 500 and 50,000 centiPoise (cP) and at 24 hours thereafter builds to between 1 million to 50 million cP, and the terminal viscosity thereafter of between 10 million and 200 million cP.

An inventive SMC composition has predictable development of viscosity and is readily adjusted to a desired viscosity to account for ambient conditions, and viscosity increases associated with the aforementioned components dispersed in the resin. As a result, an article is formed from an inventive SMC that molds well compared to a conventional like-resin SMC article while achieving superior char strength compared to like-resin based SMC absent the inventive additive loading. The properties of an inventive article are also attractive relative to aluminum for the formation of vehicle body and exterior panels. Typical molding cycle times with an inventive SMC range from 45 to 180 seconds.

The molding compounds of the present invention to be well suited for the rapid production of molded composite articles that have a high gloss finish as measured by ASTM D523 and with a reduced likelihood of surface blistering.

The present invention is particularly well suited for the production of a variety of vehicle panel products illustratively including bumper beams, fenders, vehicle door panel components, automotive floor components, spoilers, hoods, impact shields, battery boxes, and engine cradles; and various industrial and consumer product housings.

The present invention is further detailed with respect to the following non-limiting examples. These examples are not intended to limit the scope of the appended claims.

### Example 1

A formulation that includes unsaturated polyester cross-linked with styrene and domains of benzoxazine polymer as a low profile additive. The SMC composition contains 50 weight percent benzoxazine resin (BZ) in styrene monomer with 1.5 weight percent peroxide catalyst (22C80). As shown in the FIGURE, the styrene crosslinks at a mold temperature of 150° C., while the char forming reaction on the benzoxazine reaction occurs at an onset temperature of 223° C. This graph is based on data taken at 10° C./min ramp rate.

### Example 2

Flat panels 30×30 cm with a thickness of 3 mm are cured with various combinations of resin-intumescents-LPAs and subjected to an orthogonal flame modified UL 94-5VA test for burn through time. The panels included 8 phr by weight of styrene as a monomer, intumescent in amounts as noted in Table 2, 1 part by weight of LPA for every 2.5 parts by weight or resin, and 20 percent by weight chopped glass fiber. Table 2 shows results for such tests. Strengths of greater than 100 Newtons (N) are considered useful and of these, all had char thicknesses of less than 6 mm. Char strengths are measured using a IMADA ZTA-220 handheld force gauge to measure the strength of the burned area after the samples cools to room temperature. Poly glycidyl methacrylate is abbreviated as PGMA below.

TABLE 2
Test formulations and associated char strengths.

| | | | | Char |
|---|---|---|---|---|
| | | | | Strength of |
| | | | | 3 mm |
| | | | | sample after |
| | Base Resin | | | 30 min-burn |
| Formulation | (100 phr) | Intumescent | LPA | (Newtons) |
| 1 | Bis-phenol A | melamine | SBR | 170.4 |
| | epoxy vinyl | polyphosphate | | |
| | resin | | | |
| 2 | Bis-phenol A | 1,2 | sat. PE | 138.8 |
| | epoxy vinyl | ethanediamine | | |
| | resin | phosphate | | |
| 3 | PGMA-UPE | 1,2 | sat. PE | 129.9 |
| | | ethanediamine | | |
| | | phosphate | | |

TABLE 3
Test formulations and UL94-5VA Data

| For- | Base Resin | | | UL94-5VA |
|---|---|---|---|---|
| mulation | (100 phr) | Intumescent | LPA | (Seconds) |
| 4 | Bis-phenol A | Melamine | Styrene- | 24.4 |
| | epoxy vinyl | polyphosphate | butadiene | |
| | resin | | rubber (SBR) | |
| 5 | Bis-phenol A | Ammonium | PVAC | 179.3 |
| | epoxy vinyl | polyphosphate | | |
| | resin | | | |
| 6 | Bis-phenol A | Ammonium | PVAC | 135.7 |
| | epoxy vinyl | polyphosphate | | |
| | resin | | | |
| 7 | PGMA-UPE | Melamine | PVAC | 33.6 |
| | | polyphosphatc | | |
| 8 | PGMA-UPE | Ammonium | SBR | 110.8 |
| | | polyphosphate | | |
| 9 | PGMA-UPE | Ammonium | SBR | 90.5 |
| | | Polyphosphate | | |
| 10 | PGMA-UPE | 1,2 | Saturated | 26.6 |
| | | ethanediamine | polyethylene | |
| | | phosphate | (sat. PE) | |

### Example 3

Some panels of Example 2 are reformulated with an amount of the styrene replaced with trimethylolpropane triacrylate (TMPTA) by phr by weight. Strengths of greater than 100 Newtons (N) are considered useful and of these, all had char thicknesses of less than 6 mm. Char strengths are measured as noted above. Table 4 shows results for such tests.

TABLE 4
Effects of TMPTA on char strength.

| | | | | Char |
|---|---|---|---|---|
| | | | | strength |
| | | | | of 3 mm |
| | | | | sample |
| | | | | after 30 |
| | | | TMPTA | min-burn |
| Formulation | Base Resin | Intumescent | (phr) | (Newtons) |
| 11 | Bis-phenol A | Melamine | 0 | 170.4 |
| | epoxy vinyl | polyphosphate | | |
| | resin | (95 phr) | | |
| 12 | Bis-phenol A | 1,2 | 4 | 195.7 |
| | epoxy vinyl | ethanediamine | | |
| | resin | phosphate (95 | | |
| | | phr) | | |
| 13 | Bis-phenol A | Melamine | 8 | 126.3 |
| | epoxy vinyl | polyphosphate | | |
| | resin | (95 phr) | | |
| 14 | PGMA-UPE | 1,2 | 0 | 129.9 |
| | | ethanediamine | | |
| | | phosphate (20 | | |
| | | wt. %) | | |
| 15 | PGMA-UPE | 1, 2, | 4 | 147.7 |
| | | ethanediamine | | |
| | | phosphate (20 | | |
| | | wt. %) | | |
| 16 | PGMA-UPE | 1,2 | 8 | 209.5 |
| | | cthancdiaminc | | |
| | | phosphate (20 | | |
| | | wt. %) | | |

### Example 4

Panels are formed to determine the effects of confectioner's sugar. Strengths of greater than 100 Newtons (N) are considered useful and of these, all had char thicknesses of less than 6 mm. Char strengths are measured by TGA as noted above. Formulation 17 is used as a control and reproduced below with backside temperature measurement also measured. Table 5 shows results for such tests.

TABLE 5
Effects of sugar on char strength.

| | | | | Char | |
|---|---|---|---|---|---|
| | | | | strength | |
| | | | | of 3 mm | |
| | | | | sample | Backside |
| | | | | after 30 | temperature |
| For- | | | sugar | min-burn | after 30 |
| mulation | Base Resin | Intumescent | (phr) | (Newtons) | min (C) |
| 17 | PGMA-UPE | 1,2 | 0 | 209.5 | 349 |
| | | ethanediamine | | | |
| | | phosphate | | | |
| | | (95phr) | | | |
| 18 | PGMA-UPE | 1,2 | 30 | 387.4 | 336 |
| | | ethanediamine | | | |
| | | phosphate | | | |
| | | (65phr) | | | |

### Example 5

Panels are formed at 3 mm thickness as detailed above to determine the effects of phenol resin matrices. Phenolic resole resin is provided at 100 phr with a weight ratio to Novolac of 9:1. Strengths of greater than 100 Newtons (N) are considered useful and of these, all had char thicknesses of less than 6 mm. Char strengths are measured as noted above. Triethylphosphate is abbreviated as TEP in Table 6. Table 6 shows results for such tests.

TABLE 6
Effects of TEP on char strength.

| | Phenolic | | | Char | Backside |
|---|---|---|---|---|---|
| For- | Resole | Novolac | Additive/ | Strength | Temp at 30 |
| mulation | Resin | Resin | Intumescent | (Newtons) | min (C) |
| 19 | Resin 2 | Novolac | TEP (5 phr) + | 451 | Not |
| | | 1 | Silane (5 phr) | | measured |
| 20 | Resin 3 | Novolac | TEP (5 phr) + | 391 | Not |
| | | 1 | Silane (5 phr) | | measured |
| 21 | Resin 1 | Novolac | TEP (10 phr) | 359 | Not |
| | | 1 | | | measured |
| 22 | Resin 4 | Novolac | TEP (10 phr) | 168 | 535 |
| | | 1 | | | |
| 23 | Resin 4 | Novolac | TEP (10 phr) | 166 | 520 |
| | | 1 | | | |
| 24 | Resin 4 | Novalac | TEP (5 phr) + | 683 | 440 |
| | | 2 | Liquid | | |
| | | | Phosphorous | | |
| | | | Additive 1 (10 | | |
| | | | phr) | | |
| 25 | Resin 4 | Novolac | TEP (5 phr) + | 498 | 550 |
| | | 2 | Liquid | | |
| | | | Phosporous | | |
| | | | Additive 2(10 | | |
| | | | phr) | | |

Phenolic Resin 1, Resin 2, and Resin 3 are low free formaldehyde (<0.1% wt) resole resin made in production or lab settings. Phenolic Resin 4 is a low free formaldehyde (<0.1% wt.) and low free phenol (<5% wt.) resole resin. Novolac 1 is a Novolac resin with <10% methenamine. Novolac 2 is a Novolac resin with <10% methenamine and <5% resorcinol.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

1. A sheet molding compound (SMC) composition formulation comprising:
a curable resin in an ethylenically unsaturated monomer;
a low profile additive in a curable solvent; and
an intumescent additive of at least one of an intumescent char former or a char promoter;
wherein an article formed of the SMC composition formulation experiences no more than a 200% increase in thickness as compared to an initial thickness of the article after exposure to a flame.

2. The SMC composition of claim 1 wherein the resin comprises unsaturated polyester or vinyl ester.

3. The SMC composition of claim 1 wherein the resin comprises phenolics.

4. The SMC composition of claim 1 wherein the low profile additive comprises domains of benzoxazine polymer, polycarbonate, or a combination thereof.

5. (canceled)

6. (canceled)

7. The SMC composition of claim 1 wherein the intumescent char former is present and is at least one of an organic phosphate or polyphosphate, an organic nitrogen containing phosphate or polyphosphate, or a combination thereof.

8. The SMC composition of claim 1 wherein the intumescent char former is present in an amount of 15 to 125 parts per hundred by weight (phr) per 100 phr of said curable resin.

9. The SMC composition of claim 1 further comprising a thickener, said thickener being an alkaline earth oxide, an alkaline earth hydroxide, or a combination thereof.

10. The SMC composition of claim 1 further comprising a fiber reinforcement.

11. The SMC composition of claim 1 further comprising a peroxide catalyst.

12. The SMC composition of claim 1 further comprising a smolder suppressant agent of boric acid, borax, phenylboronic acid, a boroxo siloxane, or a combination thereof.

13. The SMC composition of claim 1 further comprising a thickening agent of magnesium oxide, magnesium hydroxide, calcium oxide, calcium hydroxides, zinc oxide, aluminum ion chelates, aluminum trihydrate, polyphosphate, or a combination thereof.

14. The SMC composition of claim 1 further comprising an additional component of at least one of an internal release agent, an inert solvent, a reactive diluents, a filler particulate, a colorant, or combinations thereof.

15. The SMC composition of claim 1 wherein the composition builds viscosity builds from an initial viscosity to 36 hours, from 36 to 142 hours, and then from 142 hours to 176 hours to define a slope ratio of viscosities in these time ranges of 1.5-8:1:-0.4-2 and a having terminal viscosity as measured at 176 hours, or the initial viscosity is between 500 and 50,000 centiPoise (cP) and at 24 hours thereafter builds to between 1 million to 50 million cP, and the terminal viscosity thereafter of between 10 million and 200 million cP.

16. The SMC composition of claim 1 wherein the char promoter is present and is at least one of carbon black, an organophosphate ester, an organobromine, a polyol, or a combination thereof.

17. A cured article formed of the composition of claim 1 further comprising fiber filler and having an original weight and a char strength at 3 mm thickness of between 100 and 1,000 Newtons after heating to 900 degrees Celsius.

18. The cured article of claim 17 further comprising a coating applied to a surface of the cured article, said coating being free of blisters visible to an unaided, normal human eye.

19. The cured article of claim 17 wherein the cured article has a shape of a firewall barrier, a bumper beam, an automotive door intrusion beam, an automotive door panel component, an automotive hood, an automotive trunk lid, an automotive load floor component, a pick-up box, a railcar component, a HVAC component, electrical component, or an aerospace component, a spoiler, a hood, an engine cradle, an electric vehicle battery box or portion thereof.

20. The cured article of claim 17 wherein the cured article exhibits less than 1 percent shrinkage compared to a mold in which the cured article is formed.

21. The cured article of claim 17 wherein a percent char is greater than 5 of the original weight percent.

22. The cure article of claim 20 wherein the percent char is between 10 and 70 original weight percent.
